(19) United States
(12) Patent Application Publication
(10) Pub. No.: US 2020/0392008 A1
(43) Pub. Date: Dec. 17, 2020

(54) Low Cost Synthetic Zeolite for Enhancement of Plant Growth

(71) Applicant: ZKsciences Incorporated, Chicago, IL (US)

(72) Inventors: Steven M. Kuznicki, Flagler Beach, FL (US); Natalie P. Ireland, Edmonton (CA); Daniel B. Kuznicki, Sherwood Park (CA); Michael J. Kuznicki, Lafayette, CO (US); Elizabeth A. Butler-Henderson, Parson (CA)

(21) Appl. No.: 16/900,480

(22) Filed: Jun. 12, 2020

Related U.S. Application Data
(60) Provisional application No. 62/861,495, filed on Jun. 14, 2019.

(51) Int. Cl. C01B 39/18; C09K 17/08

(52) U.S. Cl. CPC C01B 39/18; C09K 2101/00; C09K 17/08

(57) ABSTRACT

A method of plant growth promotion includes the steps of mixing synthetic high aluminum zeolite A with soil around seeds of a desired plant. The zeolite A may be ion exchanged with nutrients including a plant growth promoter chosen from the group consisting of copper, zinc and mixtures thereof included in the amount of at least about 0.04 meq/g. Preferably, the zeolite A has a moisture reserve capacity of at least about 30 wt %. Preferred synthetic zeolite A compositions may have at least double the ion exchange capacity of Clinoptilolite.

This application claims priority of Provisional U.S. Patent Application Ser. No. 62/861,495 of the same title, filed Jun. 14, 2019 incorporated by reference hereto.

Naturally occurring zeolites, such as Clinoptilolite, have long been used to enhance plant growth for grains such as wheat, corn and rice. Typically, naturally occurring zeolites have been blended into the soil adjacent the seeds or roots of the seedlings so that the benefits of nutrients and moisture stored in the zeolites are available to the root system. Even though the benefits of using naturally occurring zeolites are substantial, particularly in view of the low cost, these naturally occurring zeolites suffer in three areas: moisture retention/release properties; ion exchange capacity; and external surface area. While synthetic zeolites can excel in these areas, their cost as, typically prepared, generally makes synthetic zeolites prohibitively expensive for use as plant growth promoters. In our experience the surface area of Clinoptilolite is generally less than about 10 m²/g.

This invention relates to low-cost synthetic zeolites that can be prepared from naturally occurring sources of aluminum and silicon, typically clay, preferably kaolin, more preferably delaminated calcined kaolin, that can yield dramatic improvements in those areas but can be manufactured at a cost which does not render its use economically prohibitive, at least for plants grown in pots or greenhouses, especially for high value plants. In particular, it is possible to double or even triple the ion exchange capacity of natural zeolites such as Clinoptilolite.

In these zeolites, it is preferred that the ratio of silicon to aluminum be reduced somewhat from those typically encountered. In most naturally occurring zeolites, the ratio of silicon to aluminum is far in excess of 1 to 1 which is generally considered to be the minimum attainable. However, as the ratio of silicon to aluminum is decreased, the exchange capacity and moisture retention and release ability is increased. As a general matter, the closer the approach to 1 to 1, the more these properties are increased. In general, silicon/aluminum ratios less than about 1.75 to 1 are suitable, with ratios of less than about 1.5 to 1 being more preferred, ratios of less than about 1.25 to 1 being even more preferred. Usually, in preparation of these zeolites, higher alkalinity results in lower silicon to aluminum ratios as the degree of polymerization of the silica chains in solution is decreased with increasing alkalinity.

In the practice of this invention, we produce synthetic zeolites, especially Zeolite A, chabazite and faujasite, from naturally occurring sources of silicon and aluminum, typically clay, preferably kaolin, preferably calcined kaolin, more preferably delaminated calcined kaolin by crystallizing the naturally occurring source of silicon and aluminum under alkaline conditions, typically over at least a pH of about 10; preferably over about 10.5, more preferably over 11.0, most preferably over 11.5, more preferably over at least about 12, and ideally between about 12.5 and 13.9 or even closely approaching 14. In these zeolites, it is preferred that the ratio of silicon to aluminum be reduced somewhat from those typically encountered. In most naturally occurring zeolites, the ratio of silicon to aluminum is far in excess of 1 to 1 which is generally considered to be the minimum attainable. However, as the ratio of silicon to aluminum is decreased, the exchange capacity and moisture retention and release ability is increased. As a general matter, the closer the approach to 1 to 1, the more these properties are increased. In general silicon/aluminum ratios less than about 1.75 to 1 are suitable, with ratios of less than about 1.5 to 1 being more preferred, ratios of less than about 1.25 being even more preferred. Usually, in preparation of these zeolites, higher alkalinity results in lower silicon to aluminum ratios as the degree of polymerization of the silica chains in solution is decreased with increasing alkalinity. Typically, we will prepare these zeolites at a pH of at least about 10, preferably at least about 10.5, more preferably at least about 11, still more preferably at least about 11.5 and most preferably at least about 12, with the most preferred range being over at least about 12.5 and closely approaching 14. In most cases, treatment under these conditions at about 50° C.-100° C., more usually between about 60° C. to about 95° C., more usually from about 65° C. to about 90° C. and most typically from about 70° C. to about 80° C. for about 1 to about 8 hours, more commonly from about 1½ to about 6 hours and most preferably from about 2 to 4 hours or so is sufficient to crystallize the naturally occurring source of silicon and aluminum depending upon the chosen alkalinity and temperature. After synthesis, the pH of the zeolite should be neutralized to between about 5.5 and 10, more preferably between about 6 and 9 and most preferably to between about 6.5 and 8.5. By following the Examples herein, it is possible to ensure that the Zeolite A will have: a moisture reserve capacity of at least about 20 wt %, more preferably at least about 25 wt %, most preferably approximately 30 wt %; an external surface area of at least about 10 m²/g and an ion exchange capacity of at least about 3.5 meq/g (weight of the zeolite being on a dry weight basis, i.e, anhydrous basis), preferably above about 4 meq/g, more preferably above about 5 meq/g, still more preferably above about 6 meq/g and even still more preferably approaching 7 meq/g, it being understood that when the term meg/g is used herein, it based on meq of additive per gram of weight of the anhydrous zeolite. A plant growth promoter chosen from the group consisting of copper and zinc will be included in an amount of at least about 0.04 meq/g, preferably at least about 0.1 meq/g; more preferably at least about 0.2 meq/g; still more preferably at least about 0.3 meq/g; yet again more preferably at least about 0.4 meq/g and even more preferably at least about 1.0 meq/g and most preferably from about 0.3 meq/g to about 1.5 meq/g with loadings of up to about 4 meq/g being advantageous when conditions disfavor the use of large amounts of the base zeolite. Additionally, ammonium, magnesium and/or potassium ions may be incorporated into the zeolite in amounts of at least 0.4 meq/g, between about 0.4 meq/g up to about 5 meq/g, more preferably between about 0.45 meq/g and about 5 meq/g and most preferably between 0.5 and 4 meq/g and most preferably between about 1 and 3 meq/g.

Our experience indicates that simply by virtue of having superior moisture uptake and release properties, platy surface morphology, and ion exchange capacity, the low cost Zeolite A that we produce is far more beneficial to plant growth than any of the common naturally occurring zeolites that can be purchased at prices making them suitable for use in agriculture and horticulture. When various plant nutrients are added to the Zeolite A, the benefits of use of the present invention are even more dramatic.

### BRIEF DESCRIPTION OF THE DRAWINGS

The file of this patent contains at least one drawing executed in color. Copies of this patent with color drawings will be provided by the Patent and Trademark Office upon request and payment of the necessary fee.

FIG. 1 illustrates the bud and flower count of Marigolds grown in beds augmented with the zeolites of the present invention to Marigolds grown in beds augmented with a competitive supplement and with no additives.

FIG. 2 illustrates the progressive bud and flower count of Marigolds grown in beds augmented with the zeolites of the present invention to Marigolds grown in beds augmented with a competitive supplement and with no additives.

FIGS. 3A & 3B illustrate the striking difference in appearance of marigolds grown in bed supplemented with the zeolites of the present invention as compared to control group marigolds.

FIGS. 4 and 5 illustrate the appearance of dwarf marigolds grown in beds supplemented with the zeolite of the present invention (FIG. 4) as compared to dwarf marigolds grown in the control beds (FIG. 5).

FIGS. 6A and 6B illustrate the dramatic improvement in proliferation of flowers, buds and leaves as well subjective appearance of marigolds when raised in soil treated with the compositions of the present invention as compared to control plants.

FIGS. 7 and 8 illustrate the variations raised in beds augmented with various amounts of compositions of the present invention. Note that paradoxical results are reported and discussed but the paradox remains unresolved.

FIGS. 9-17 illustrate the dramatic improvements in growth of radishes when raised in beds augmented with compositions of the present invention.

FIGS. 18-21 illustrate the improvements possible in growing of violets in soil treated with the compositions of the present invention.

FIGS. 22A & 22B compare the 6 week growth results on the array of plants as potted (22A) with the striking differences in growth attainable through augmentation of the bed without materials.

FIGS. 23 & 24 illustrate the Cannabis sativa seedlings as planted.

FIG. 25 demonstrates the growth of a control plant 2A versus a plant 5B grown with 10 g of the most preferred zeolite of the present invention (no fertilizer added), thus illustrating the dramatic benefits that use of the preferred exchanged zeolite can bestow upon growth of Cannabis sativa.

FIGS. 26A & 26B illustrate plant 1A, as planted and after 11 weeks of growth.

FIGS. 27A & 27B illustrate two views of plant 1B after 11 weeks.

FIGS. 28A & 28B illustrate plant 2A, as planted and after 11 weeks.

FIGS. 29A & 29B illustrate plant 3A, as planted and after 11 weeks.

FIG. 30 illustrates plant 3B after 11 weeks.

FIGS. 31A & 31B illustrate plant 4A, as planted and after 11 weeks.

FIG. 32 illustrates plant 4B after 11 weeks.

FIGS. 33A & 33B illustrate plant 4A, as planted and after 11 weeks.

FIGS. 34A & 34B illustrate plant 6A, as planted and after 11 weeks, and demonstrate the effect of decreasing the amount of the most preferred zeolite of the present invention while adding fertilizer in an amount of 0.5 g.

FIG. 35 illustrates the buds on a plant grown using the most preferred exchanged zeolite A of the present invention. The size of the bud set is considered extremely significant with a plethora of trichomes being considered indicative of a high yield.

### DETAILED DESCRIPTION

Conversion of Base Stock into Zeolite A:

Synthesis Method and Theory

The basics of the material synthesis of the materials of the present invention can be broken up into two parts:

The Conversion of Metakaolin Into a Platy Form of Zeolite A

The exchange of zeolite A, replacing the sodium ions inside of the material with a variety of minerals that promote plant growth.

Step 1 is roughly a 4 hours process, using various temperature points up to 80° C.

Step 2 is a two day process, using the platy material and the nutrient salts. This step is more time intensive and labor intensive however.

The finished material treated with zinc and copper will come out looking like a slightly green, sand like material that can then be mixed into the potting soil of the targeted plant, and will do its work from there.

Zeolite Production Procedure

A 12 Liter, stainless steel pot is placed into a water bath set to 50° C., and an overhead stirrer set to low is placed inside of it. Into the pot, is placed the following:

3308 g of RODI (Reverse Osmosis Deionized) water

520 g of NaOH pellets, added over the course of 2 minutes.

The two are allowed to mix for roughly 5 minutes, or until all of the NaOH pellets are observed to be dissolved.

At that point, 888 g of base stock metakaolin clay is added slowly over the course of another 5 minutes, to prevent clumping.

After all the reagents are added, the material is allowed to cook for 1 hour at 50° C. At that point, the temperature is increased to 80° C., and allowed to cook for another three hours.

Once completed, the material is washed in a Büchner funnel, and dried at 80° C. in a laboratory oven. In some cases, the exchanged zeolite was used without drying. In these cases, it was found that 10 g of undried zeolite was roughly equivalent to about 6 g of dried zeolite.

Neutralization and Incorporation of Plant Growth Nutrients

The following ingredients:
600 g RODI water
54.81 g MgCl₂.6H₂O
62.73 g K₂SO₄
37.61 g NH₄NO₃
11.89 g Zn(NO₃)₂.6H₂O
4.83 g Cu(NO₃).3H₂O
   were added to an acceptable, unreactive container equipped with an overhead stirrer, the stirrer being operated at room temperature until all solids are dissolved into the solution. Upon complete dissolution, 300 g of the synthesized zeolite A was blended into the solution and thereafter mixed for about of 3 hours. Upon completion, the material was washed in a Büchner funnel and dried at 80° C. in a laboratory oven. Amounts are per 300 g of synthesized zeolite A, when done. This amounts to 20 mmol Cu/300 g Zeolite A and 40 mmol Zn/300 g Zeolite A which is 0.067 mmol Cu/g Zeolite A and 0.133 mmol Zn/g Zeolite A or 0.4 wt % Cu and 0.83 wt % Zn. This composition was dubbed “Exchanged Zeolite regular metals.”

The above preparation was repeated except that the amounts of copper and zinc added were doubled. This composition was dubbed “Exchanged Zeolite high metals.”

In use, the platy high aluminum synthetic zeolite A of the present invention will typically be mixed with the soil the plant is to be grown in at a weight percentage of about 5% if the zeolite has been dried or 10% if undried. Beneficial results can be obtained with relatively small amounts of zeolite, desirably from 1 to about 20% by weight undried, preferably from about 2 to about 18%, more preferably from about 3 to about 15%, still more preferably from about 3.5 to 12%, and most preferably from about 4 to about 10%. In some cases, the root ball of seedlings still encased in the potting soil may be rolled in the zeolite or the root balls may be dusted with zeolite. Use of the platy high alumina synthetic zeolite A of the present invention will not only provide water uptake and release properties easing issues of watering but when nutrients are exchanged into the zeolite, extended supply of nutrients is extremely beneficial.

### Plant Growth Examples

Activities were performed as set out in Appendix A below.

Potting soil was amended with about 5% dry weight or 10% undried (by weight) as indicated of:

the platy high aluminum synthetic zeolite A of the present invention exchanged with nutrients and growth promoting metals prepared as described above exchanged with 20 mmol Cu/300 g Zeolite A and 40 mmol Zn/300 g Zeolite A which is 0.067 mmol Cu/g Zeolite A and 0.133 mmol Zn/g Zeolite A or 0.4 wt % Cu and 0.83 wt % Zn referred to as: “Exchanged Zeolite regular metals”;

the platy high aluminum synthetic zeolite A of the present invention exchanged with nutrients and growth promoting metals prepared as described above but exchanged with 40 mmol Cu/300 g Zeolite A and 80 mmol Zn/300 g Zeolite A which is 0.134 mmol Cu/g Zeolite A and 0.266 mmol Zn/g Zeolite A or 0.8 wt % Cu and 1.66 wt % Zn, referred to as: “Exchanged Zeolite high metals”;

the platy high aluminum synthetic zeolite A of the present invention but without added nutrients and plant growth promoters; “raw platy high aluminum synthetic zeolite A”;

naturally occurring clinoptilolite; or

a control with no added zeolite.

### Marigolds

### Overview

In general, experiments were set up with four groups in mind:

Group 1—Soil with commercial fertilizer and 5% by dry weight of exchanged material of the present invention;

Group 2—Soil with commercial fertilizer and 2.5% by dry weight of exchanged material of the present invention;

Group 3—Soil with commercial fertilizer (Control 1);

Group 4—No fertilizers (Control 2).

Multiple plants were used per group to hedge against outliers. Where possible, pictures were taken every day, and plant material (flowers, buds, leaves) were counted once per week.

A series of pots were prepared for marigolds:

Conventional Miracle Grow potting soil enriched with 10 wt % of as produced (undried) Exchanged Zeolite, regular metals was placed in pot 1.

Conventional Miracle Grow potting soil enriched with 5 wt % of as produced (undried) Exchanged Zeolite, regular metals was placed in pot 2.

Conventional Miracle Grow potting soil enriched with 5 wt % of commercially available Clinoptilolite was placed in pot 3.

Conventional Miracle Grow potting soil enriched with Miracle Grow Plant Fertilizer was placed in pot 4—Control 1.

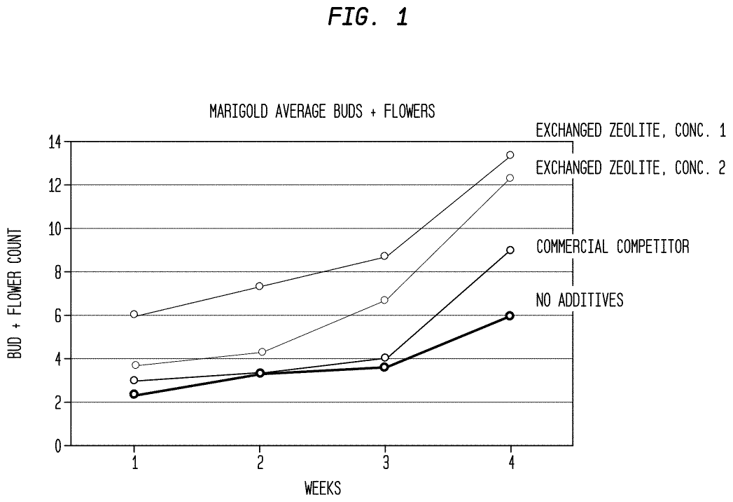

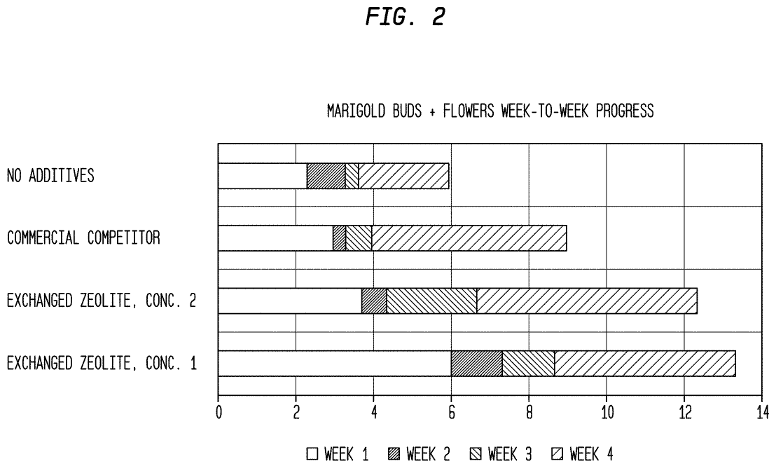

Marigolds seedlings were transplanted into the pots which were watered every other day and the plants were observed with the results being as presented in FIGS. 1 & 2.

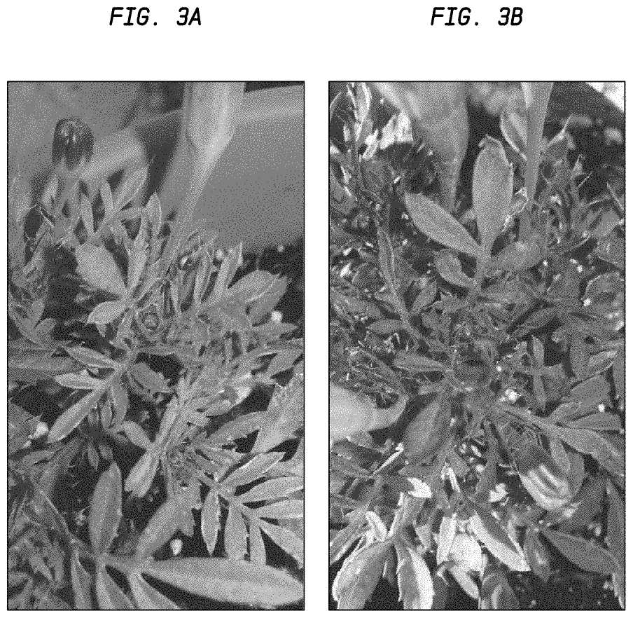

FIGS. 3A & 3B illustrate the appearance of the marigold plants at 4 weeks of growth.

FIG. 3A depicts the best marigold from the control group, whereas the plant depicted in FIG. 3B is the best-looking plant from the group grown with the exchanged material of the present invention (high metals).

Subjective looks aside, plants grown with materials of the present invention (FIG. 3B) had more leaves, buds and flowers over the course of the growth experiment than any of the other groups, with the pots having the highest level of zeolite exhibiting a flower/bud ratio of 3:1 over the control group. This assessment could again be followed by the plants with the highest levels of treated zeolite (Group 1) being better than the plants with the lower level (Group 2), which was better than the plants with commercially available Clinoptilolite {Group 3}, which was better than the control (Group 4).

### Dwarf Marigolds—Grow 2

A second batch was done late in the growing season, starting in mid-August. This experiment had the same general set up as the first, only we tested growing the marigolds out of season, so see how the materials of the present invention would impact plant survivability.

Here some oddities were shown, as group 2 using exchanged zeolite material at lower ratio out performing everything. Group 4 with the highest level of exchanged zeolite fared the worst, though the grower was unsure if that was due to the conditions the plant saw, or simply it's positioning in the sun.

Group 2 however, faired very well, achieving a flower/bud ratio nearing 3:1 over the control.

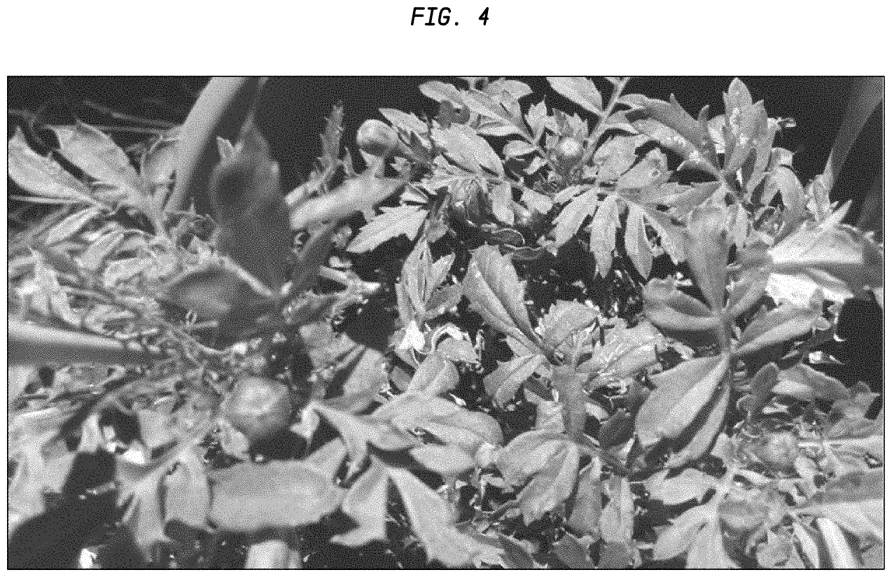

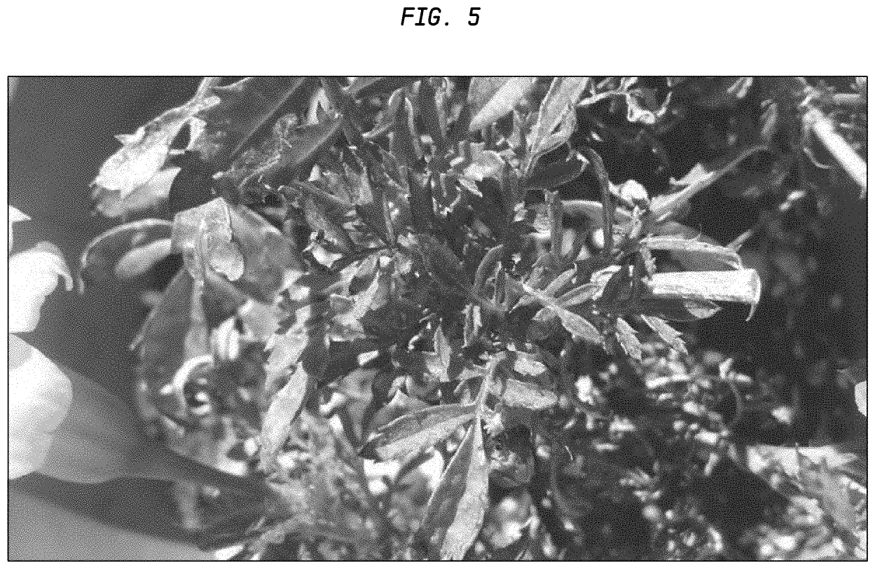

FIG. 4 depicts a group 2 marigold, grown using platy high aluminum synthetic Zeolite A, producing flower buds in late September. FIG. 5 depicts a marigold plant from the control group at the same time period.

In general, the material of the present invention—“platy zeolite A”, has consistently out-performed other forms of plant foods in terms of biomass attained, strength of plants, and number of seeds produced.

In summary, many items here can be generalized as follows subject to the understanding that not every plant will respond identically:

Multiple plants were used per group to hedge against outliers. Where possible, pictures were taken every day, and plant material (flowers, buds, leaves) were counted once per week.

### Dwarf Marigolds—Grow 1

Our first attempt at growing something with our material. This was done early in the growing season, mid May 2017, and served as our proof of concept. The flowers were broken up into 4 groups:
1) Our exchanged material at approximately 5% dry weight, along with commercial fertilizer;
2) Our unexchanged material, at approximately 2.5% dry weight along with some commercial fertilizer;
3) Flowers grown with just commercial fertilizer (Control 1);
4) A control group simply using top soil (Control 2).

As expected over the course of the month, group 1 did better than 2, which did better than 3, which did better than 4.

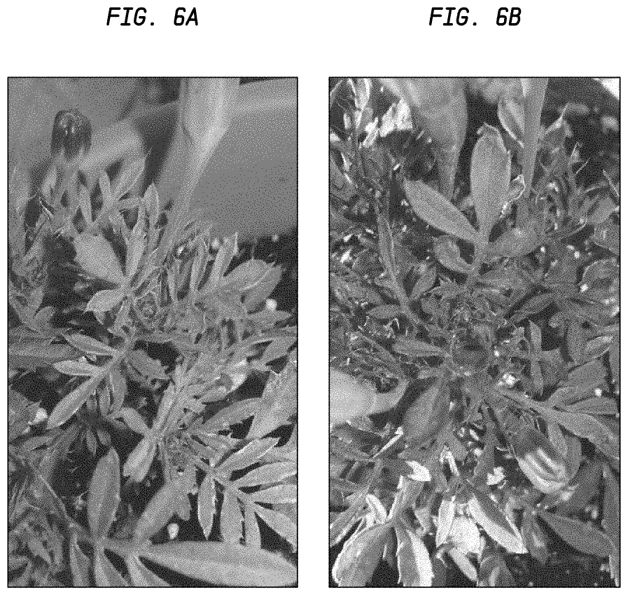

For comparison FIGS. 6A & 6B depict the best marigold from the control group (6A), where the plant on the right (6B), is the best looking plant from the group grown with the exchanged material of the present invention.

Subjective looks aside, plants grown with the material of the present invention had more leaves, buds and flowers over the course of the grow experiment than any of the other groups. With group 1 possessing a flower/bud ratio of 3:1 over the control group. This assessment could again be followed by group 1 being better than 2, which was better than 3, which was better than 4.

This second batch was done late in the growing season, starting in mid-August. This experiment had the same general set up as the first, only we tested growing the marigolds out of season, so see how our material would impact plant survivability.

Here some oddities were shown, as group 2, the group using our material but at a lower ratio than group 1, outperformed everything. Group 1 fared the worst, though our grower was unsure if that was due to the conditions the plant saw, or simply it's positioning in the sun.

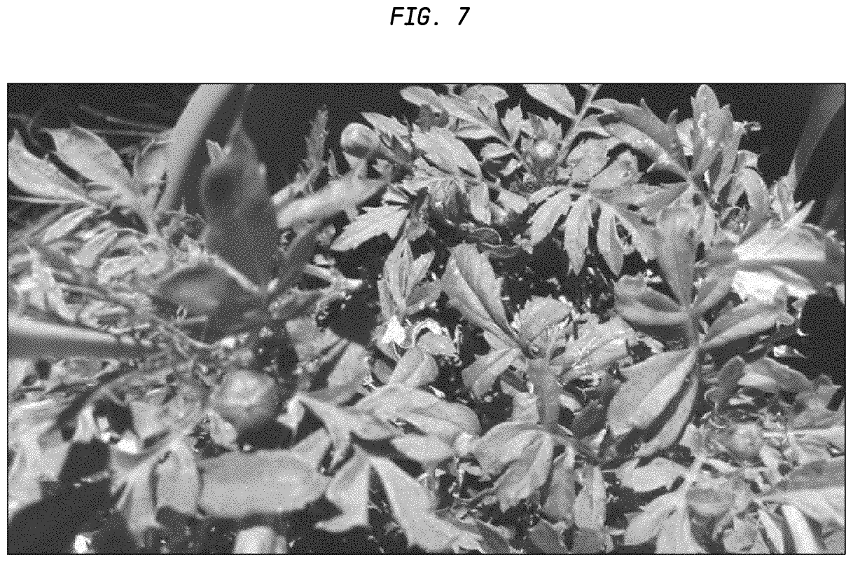

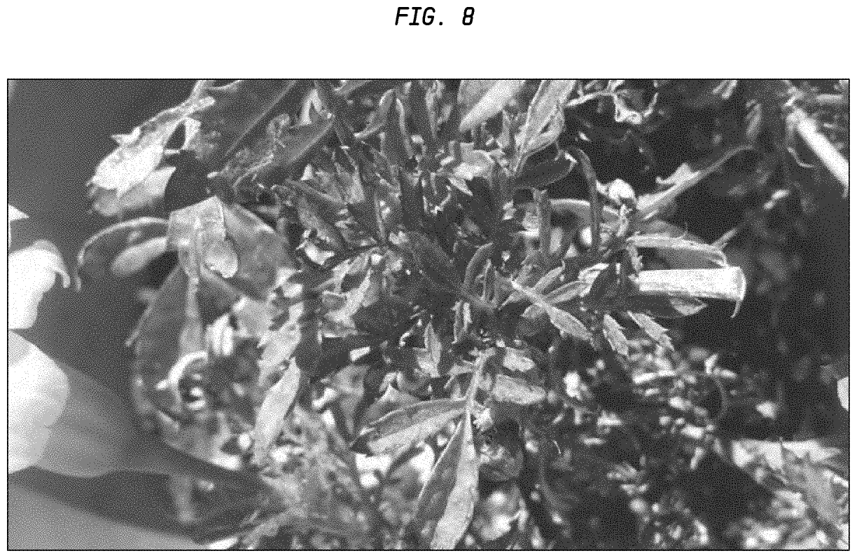

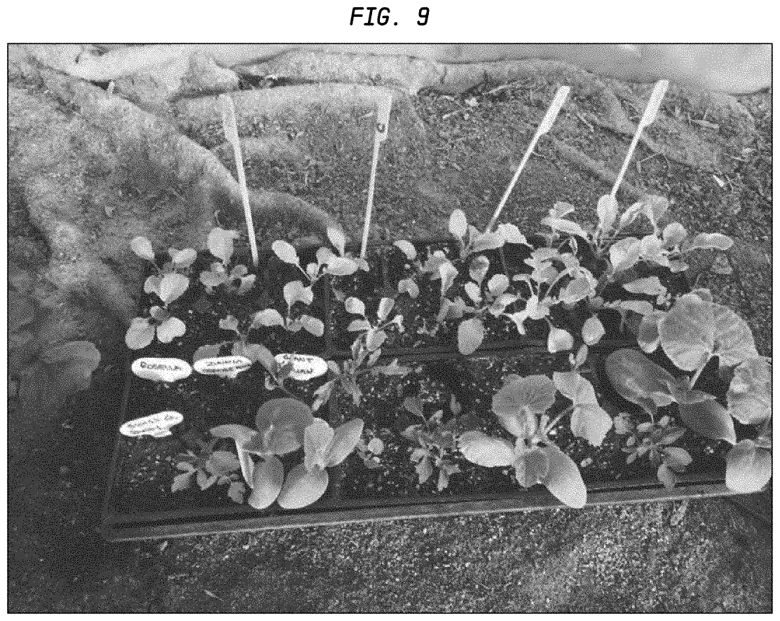

Group 2 however, faired very well, achieving a flower/bud ratio nearing 3:1 over the control. FIG. 7 depicts a group 2 marigold, grown using the material of the present invention, producing flower buds in late September which is considered exceptional given the time of year. FIG. 8 depicts a marigold plant from the control group at the same time period. Note absence of buds, damaged and dying leaves.

### Radishes.

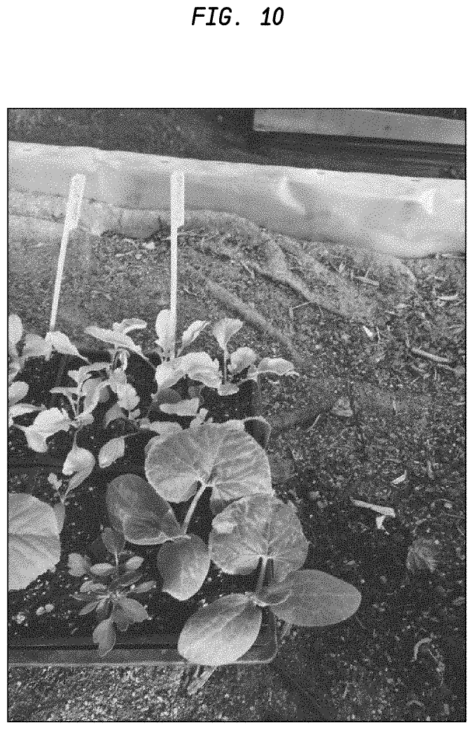

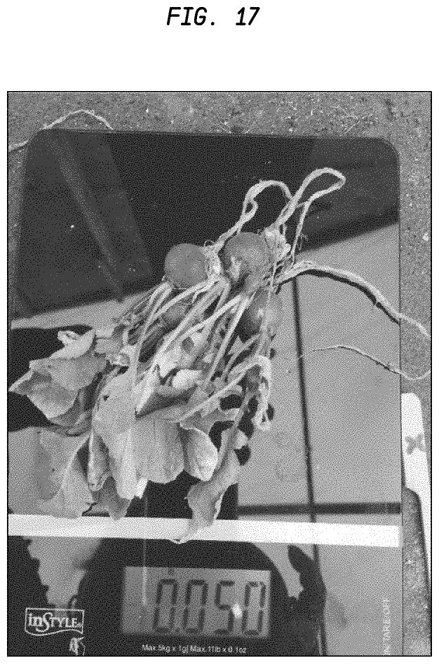

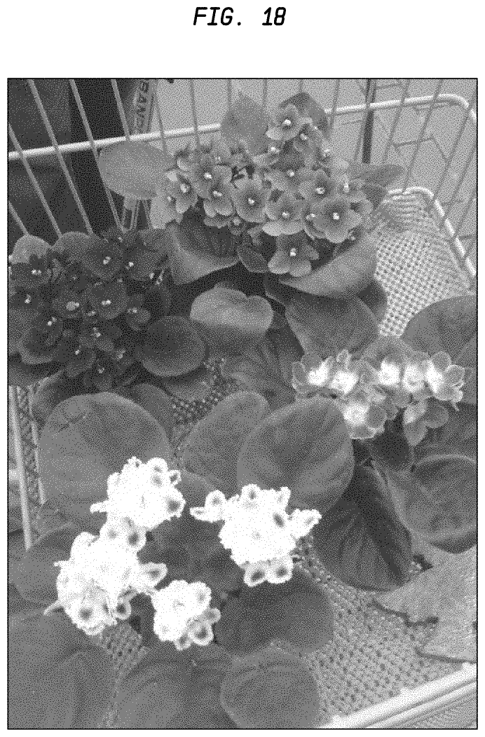

FIGS. 9-17 illustrate results obtained growing radishes, grown from seeds in 4 pots as above, being watered twice a week. The first photographs were taken 4 weeks after planting.

FIG. 9 compares (I to r) radishes grown with raw, control, regular metals and high metals. FIG. 10 depicts radishes grown in soil enriched in exchanged Zeolite A high metals and control.

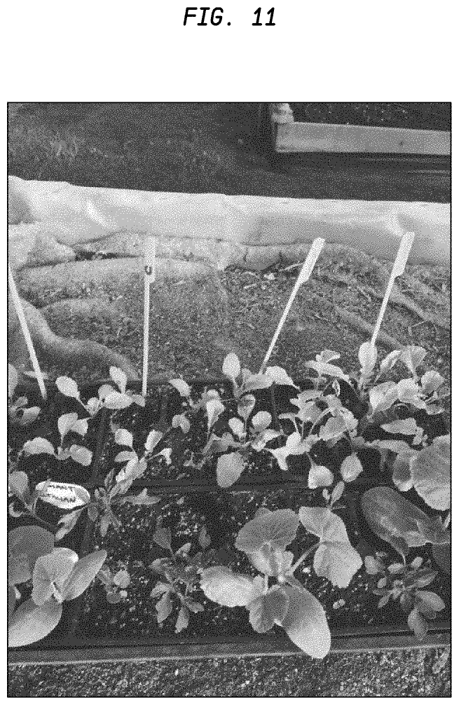

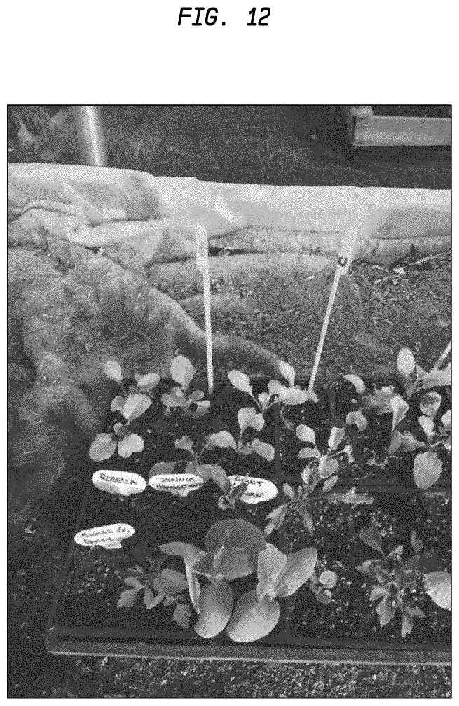

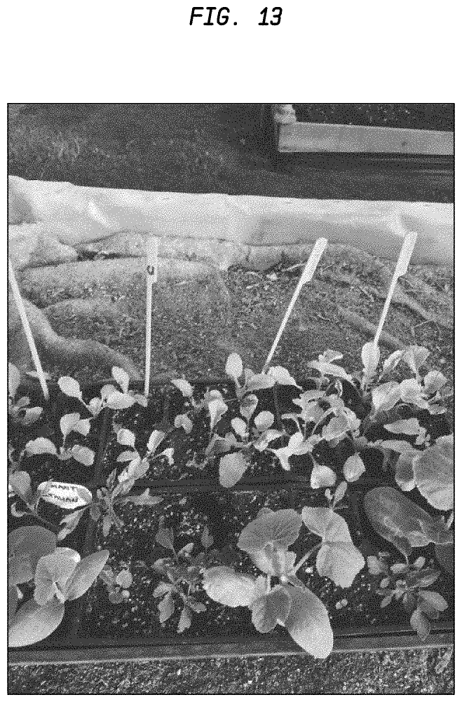

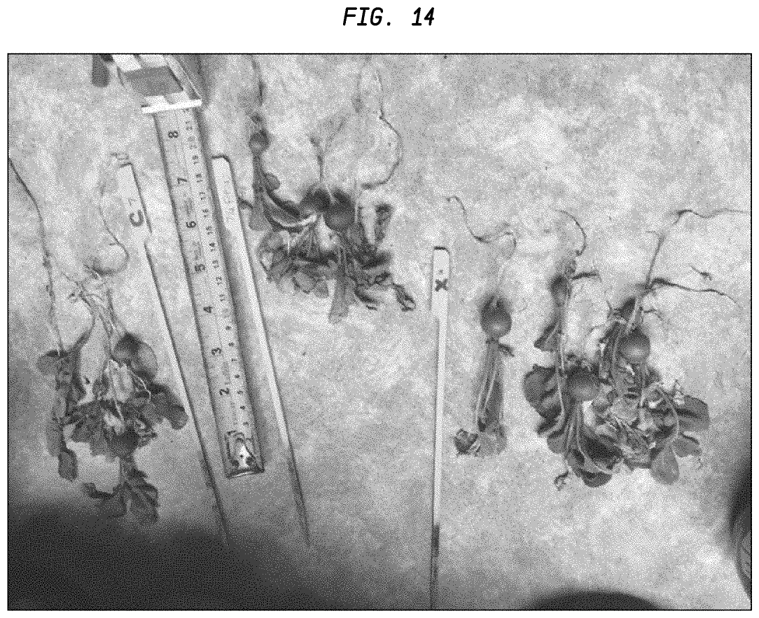

FIG. 11 presents a comparison of (I to r) radishes grown with raw, control, regular metals and high metals, while FIG. 12 presents a comparison of radishes grown in control and in raw Zeolite A and FIG. 13 presents a comparison of radishes grown in raw, control, regular metals, and high metals. FIG. 14 depicts radishes as harvested after about 5 weeks grown in beds enriched with (I to r) Control; Raw, and Exchanged.

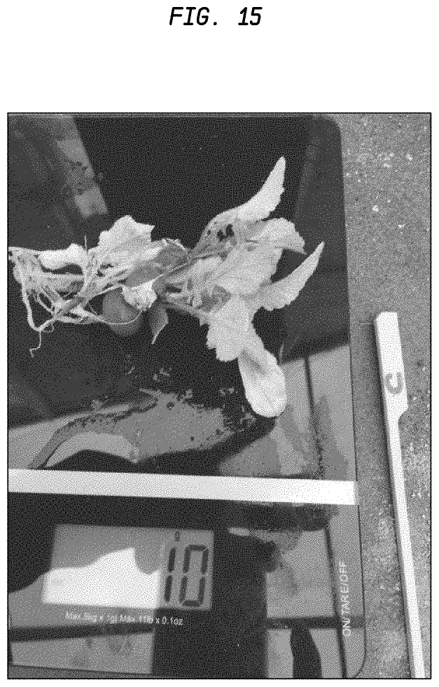

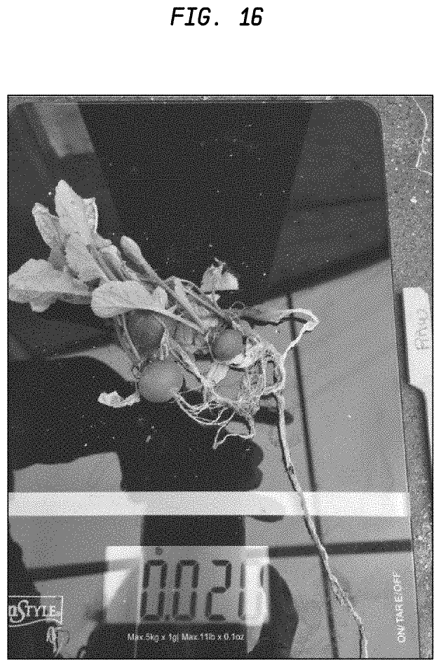

FIGS. 15-17 depicts respectively radishes grown in beds supplemented with control (note radishes weight of 10 grams); Zeolite A—note weight of 0.021 lbs=9.5 grams; and Exchanged Zeolite A—note radishes weight of 0.050 lbs.=22.6 g.

### Violets

Similar to the second marigold group, this was a test to grow a plant far out of season, and see how it faired with our material. Here, violets were grown indoors between late November and December of 2017.

Here again, plants with our exchanged material mixed in was able to sustain all of its flowers, though no significant growth was noted. All other groups, without exchanged materials, saw significant (>50%) plant death, with the control plant being completely dead by the end of the month.

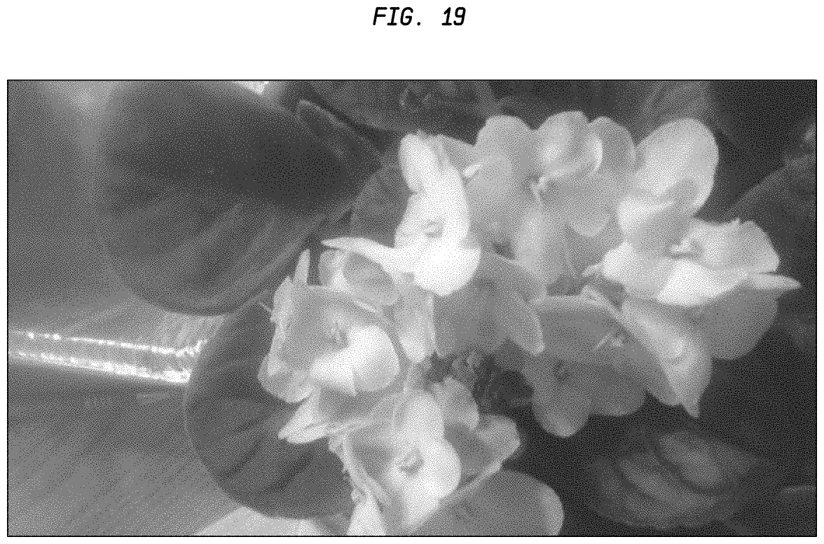

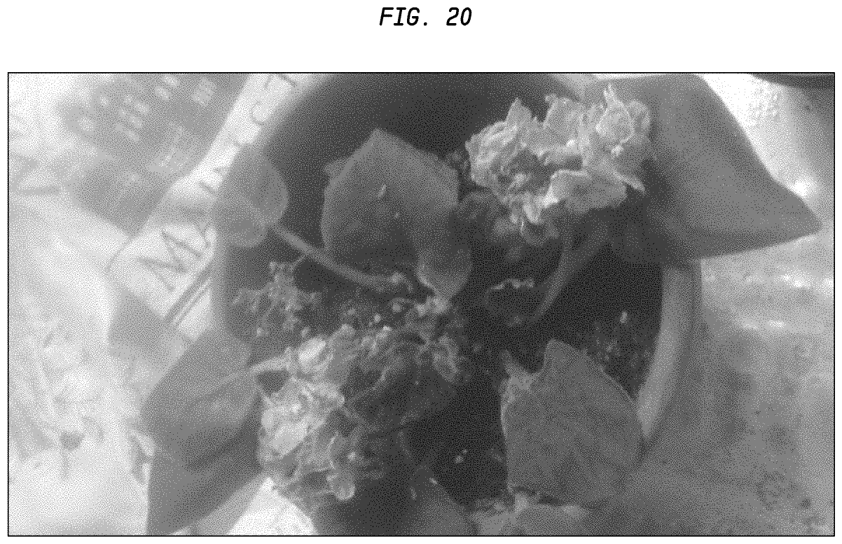

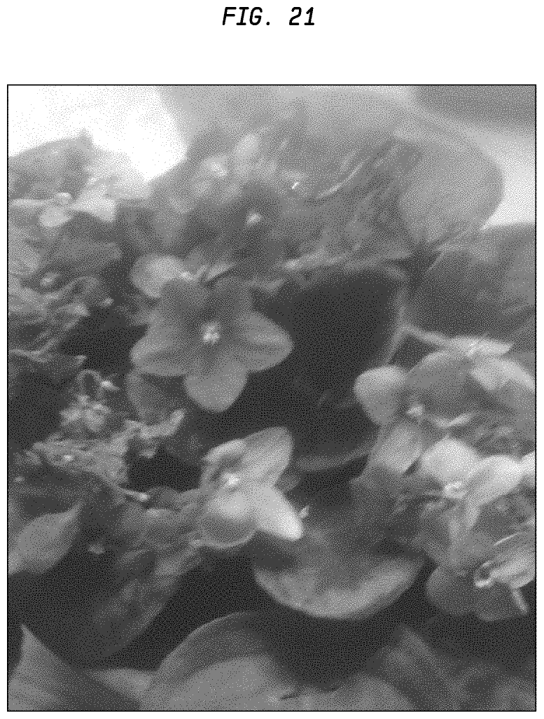

FIG. 18 depicts the violets as purchased; (4 hot house grown violets in late November); while FIG. 19 shows a white violet planted with our exchanged material, grown indoors in December; FIG. 20 depicts a control group violet grown at the same time and FIG. 21 depicts a violet grown in soil amended with our raw (un-exchanged) zeolite.

### Grass Experimentation

In Florida, on a property near Beach side, a grow experiment was performed on grass, to see how our material would work in a more distributed fashion, and in a high salt environment.

Similar to the above experiments, our material had a significant impact on the tested area. The grower reported that the grass grown with our material lightly, and evenly spread out over a patch of grass, grew faster, stronger and greener than all other groups.

8 squares 12 or 24 grams of additive was applied to each of 8 2′×2′ squares of St. Augustine grass, as follows:
Square 1: 12 g of Miracle Gro Fertilizer;
Square 2: 12 g of Miracle Gro Fertilizer+12 g of Zeolite A;
Square 3: 12 g of Miracle Gro Fertilizer+12 g of Zeolite A impregnated with Zn, Cu, ammonium and phosphate;
Square 4: 6 g of Miracle Gro Fertilizer+6 g of Zeolite A impregnated with Zn, Cu, ammonium and phosphate;
Square 5: 12 g of Zeolite A;
Square 6: 12 g of Zeolite A impregnated with Zn, Cu, ammonium and phosphate;
Square 7: 24 g of Zeolite A;
Square 8: 6 g of Miracle Gro Fertilize+6 g of Zeolite A.

The remainder of the lawn was untreated and can be considered the control.

After 2 months, boxes 3 and 1 appeared the most vigorous, followed by boxes 4 and 2, boxes 5-8 were only slightly improved over the control, if improved at all. It is not understood why square 1 should have such a positive appearance, except possibly that it was in a partially shaded region.

### Summary of Cannabis Sativa Trial Results

The test was done in 6 sets, each of 2 plants, all in small pots with combined soil, fertilizer and zeolite as follows (measurements in grams):
Group 1: 10 g green (supplemented) ZKsciences zeolite, 0.5 g commercial fertilizer, 94.5 g potting soil;
Group 2: 0.5 g commercial fertilizer, 99.5 g potting soil;
Group 3: 5 g natural (non-ZKsciences) zeolite, 0.5 g commercial fertilizer, 94.5 g potting soil;
Group 4: 5 g white (non-supplemented) ZKsciences zeolite, 0.5 g commercial fertilizer, 94.5 g potting soil;
Group 5: 10 g green (supplemented) ZKsciences zeolite, 94.5 g commercial potting soil;
Group 6: 5 g green (supplemented) ZKsciences zeolite, 0.5 g commercial fertilizer, 94.5 g potting soil.

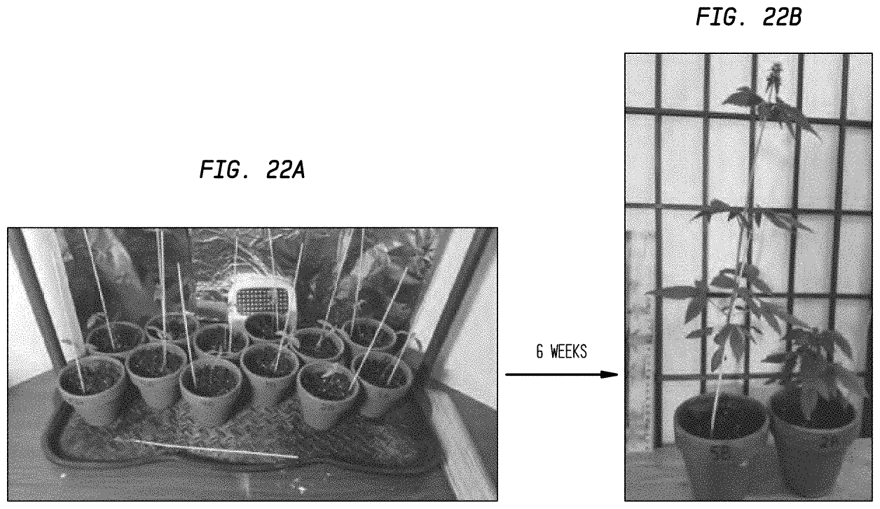

All plants were the same genetics using controlled feminized seeds. All plants had uniform watering that was the same in volume and timing. All plants shared the same light sources and their positions were rotated daily. FIGS. 22A & 22B compare the 6 week growth results on the array of plants as potted (22A) with the striking differences in growth attainable through augmentation of the bed without materials. The following Table summarizes the results obtained.

### Summarized Count of Seed Production:

| Plant group | Seeds: plant 1 | Seeds: plant 2 |
|---|---|---|
| 1 | 23 | 18 |
| 2 (“control” - | removed - aphid | 10 |
| no zeolite) | infestation | |
| 3 (“control” - | 28 | 30 |
| competitor zeolite) | | |
| 4 | 42 | 26 |
| 5 | removed - aphid | removed - aphid |
| | infestation | infestation |
| 6 | 15 | removed - aphid |
| | | infestation |

An aphid infestation caused the removal of plants 1A, 6B, 5A and 5B. Plants 4B and 1B went hermaphroditic, causing them to impregnate all of the remaining plants, including themselves.

Plant group “4” had the highest average seed count (34), a 17% improvement over the control competitor zeolite group “2”. Plant group “1” had a lower average seed count (20.5), a 29% decrease from the control competitor zeolite group “3”. Of course, due to the small size of this trial, the ability to draw statistically valid conclusions may be limited.

Though the trial had to be cut short due to hermaphroditic plants, there were encouraging signs. The test was tainted when 2 of the plants became hermaphroditic, but still yields useful insight on the effect of zeolite solution of the present invention. While it would be better to be able to look at the weight of “buds”, the amount of seeds present in each plant provides a useful indicator as seeds are indicative of the amount of energy and resources available to the plant which would amount to more “buds” per plant had they not been impregnated.

Although the test was imperfect, the data seems to suggest that zeolite has a positive effect on Cannabis Sativa plants and the ion-exchanged zeolite had an even greater impact. If it takes an amount of resources and energy to make more “buds” and seeds, then plants with the ion-exchanged zeolite of the present invention clearly had more available to it indicating that the results of this test are clearly positive.

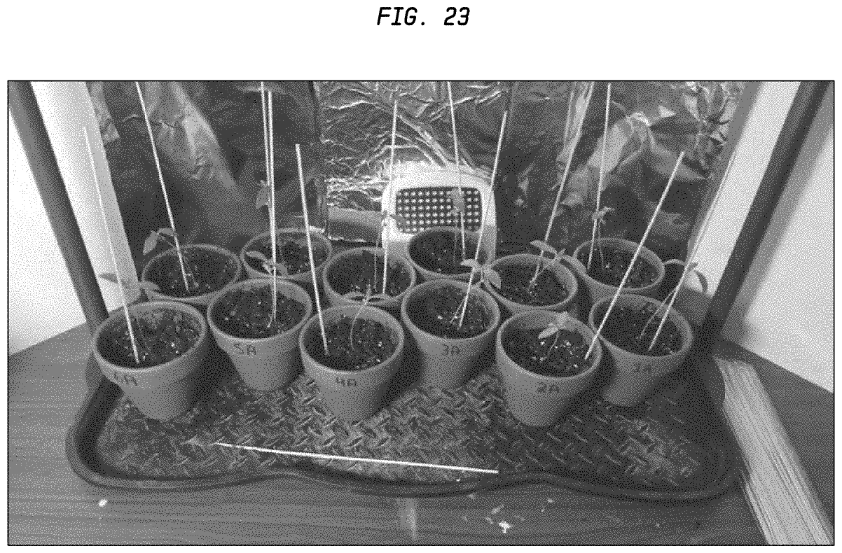

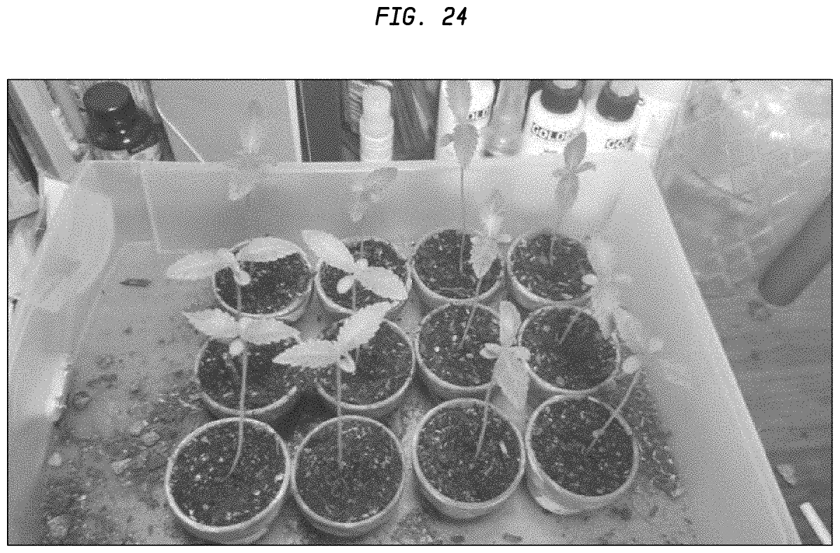

FIGS. 23 & 24 illustrate the Cannabis sativa seedlings as planted.

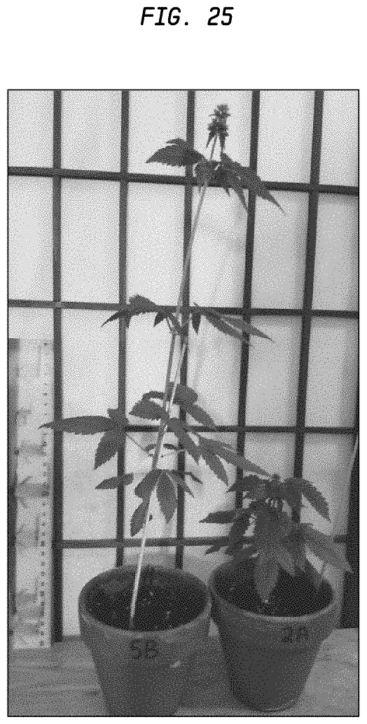

FIG. 25 demonstrates the growth of a control plant 2A versus a plant 5B grown with 10 g of the most preferred zeolite of the present invention (no fertilizer added), thus illustrating the dramatic benefits that use of the preferred exchanged zeolite can bestow upon growth of Cannabis sativa.

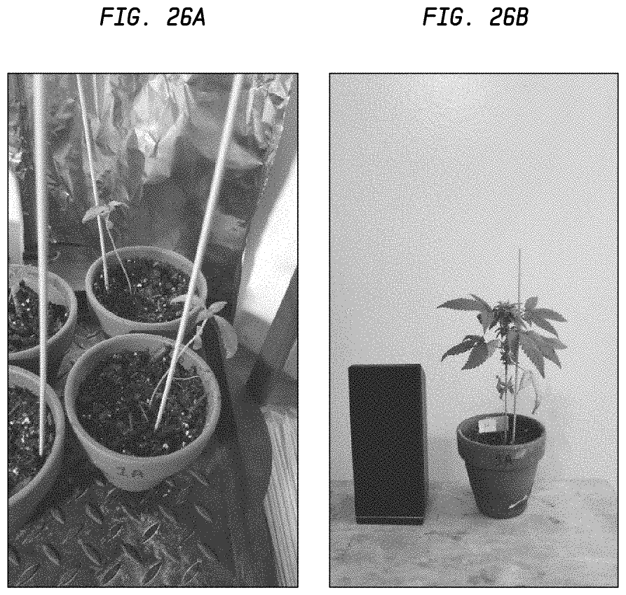

FIGS. 26A & 26B illustrate plant 1A, as planted and after 11 weeks of growth.

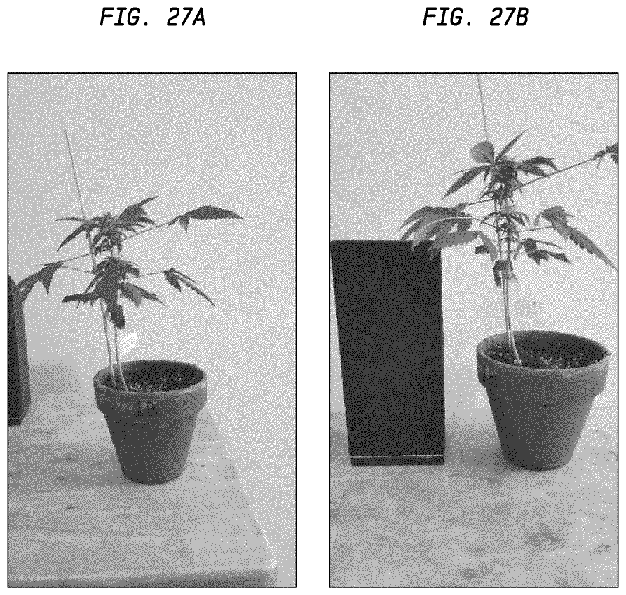

FIGS. 27A & 27B illustrate two views of plant 1B after 11 weeks.

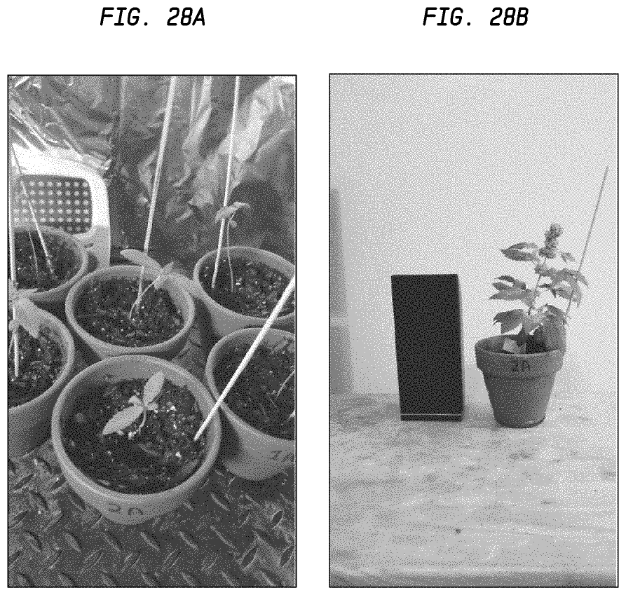

FIGS. 28A & 28B illustrate plant 2A, as planted and after 11 weeks.

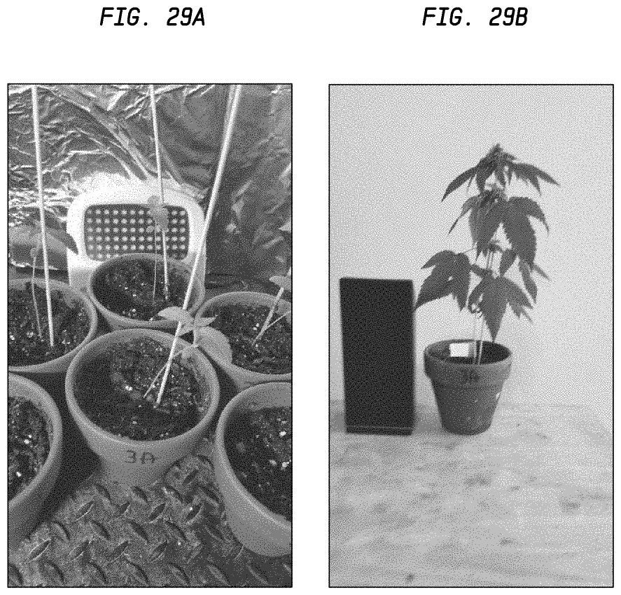

FIGS. 29A & 29B illustrate plant 3A, as planted and after 11 weeks.

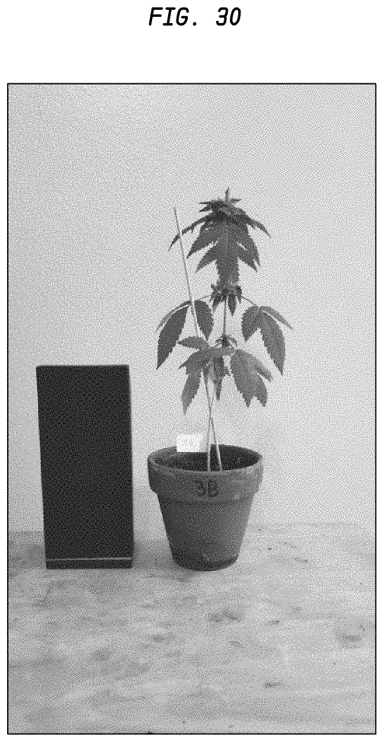

FIG. 30 illustrates plant 3B after 11 weeks.

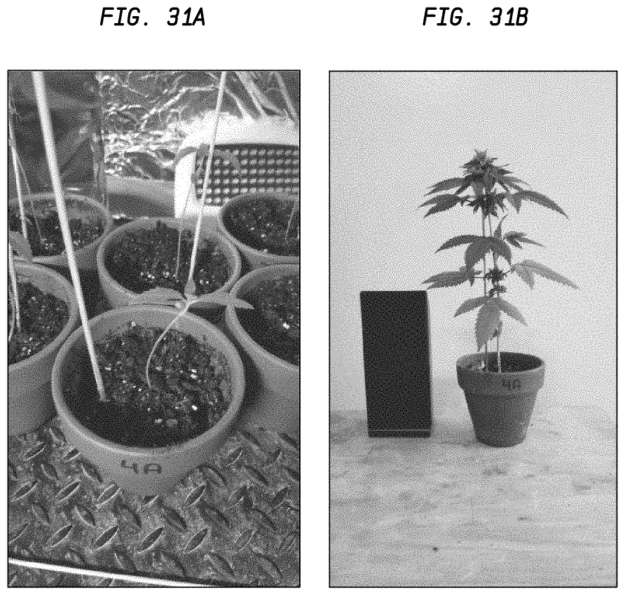

FIGS. 31A & 31B below illustrate plant 4A, as planted and after 11 weeks.

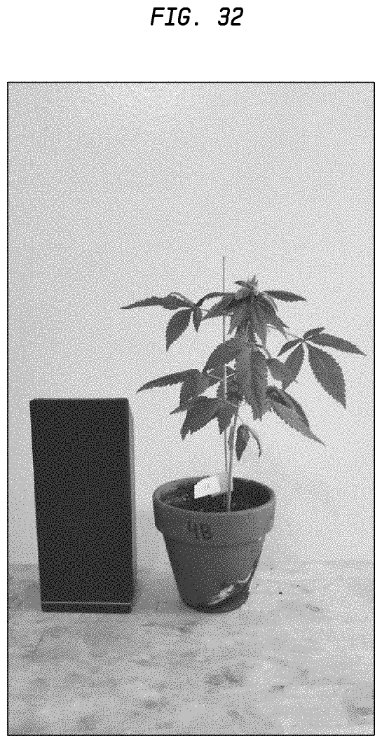

FIG. 32 illustrates plant 4B after 11 weeks.

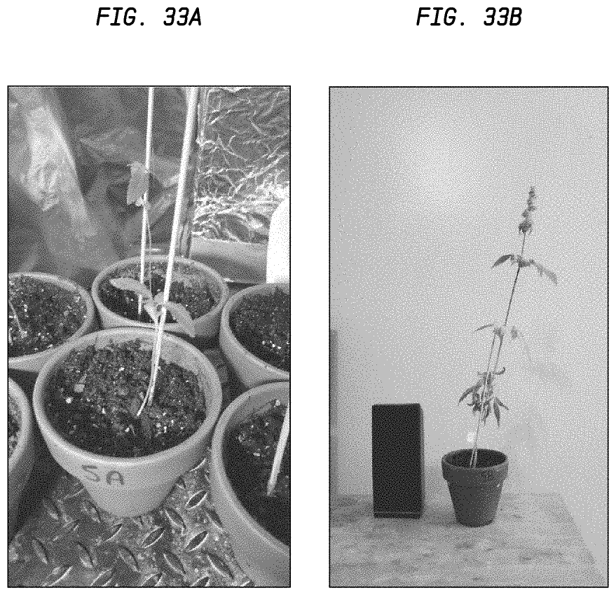

FIGS. 33A & 33B illustrate plant 4A, as planted and after 11 weeks.

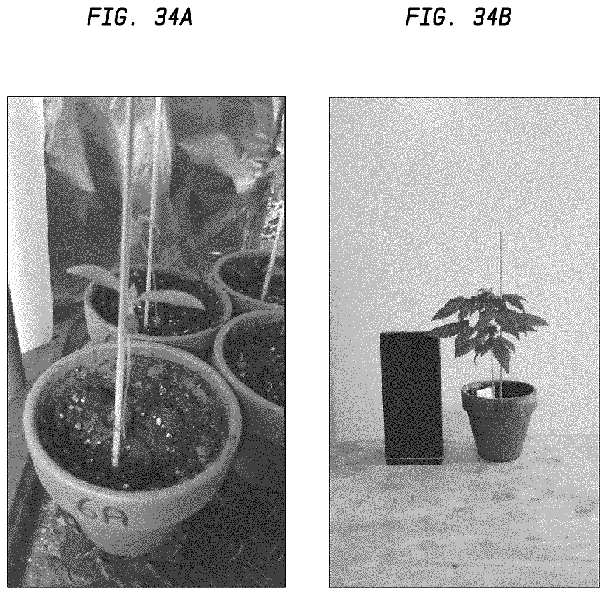

FIGS. 34A & 34B illustrate plant 6A, as planted and after 11 weeks, and demonstrate the effect of decreasing the amount of the most preferred zeolite of the present invention while adding fertilizer in an amount of 0.5 g.

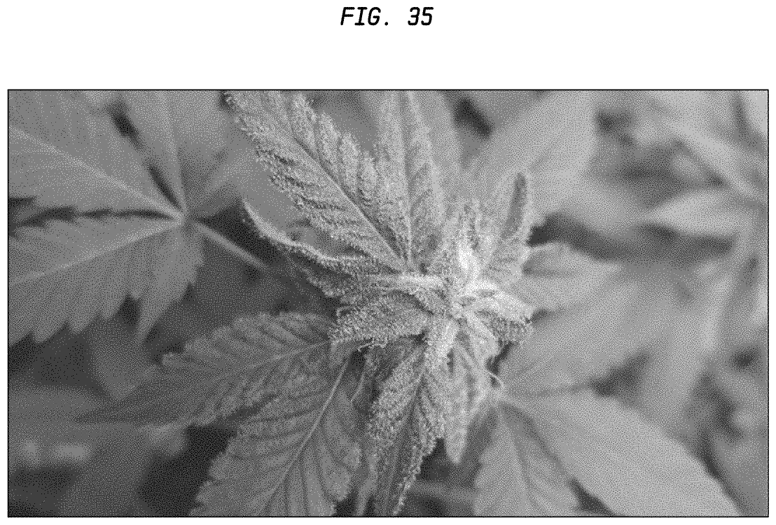

FIG. 35 illustrates the buds on a plant grown using the most preferred exchanged zeolite A of the present invention. The size of the bud set is considered extremely significant with a plethora of trichomes being considered indicative of a high yield.

APPENDIX A

| Date | Activity | Observations | Actions |
|---|---|---|---|
| 13-Apr. | Start of first test with | Bag weighs 6.025 lbs/272.6 | Mixed with exchanged zeolite |
| | Miracle Grow (only soil | grams | 1/19. Seeded/planted seedlings |
| | available as no nurseries | | in two lots of 12 peat pots (one |
| | in area open yet) | | control-seedlings from other |
| | | | person - not great quality) |
| 24-Apr. | observation of | Corn in exchanged soil much | |
| | ornamental corn | bigger | |
| 25-Apr. | planted hanging baskets | no heat in greenhouse - plastic | turned on heating cable in |
| | and moved all plants to | cover old 10 years+ | attempt to protect seedlings |
| | greenhouse | | from cold |
| 29-Apr. | inspected plants after | ornamental corn seedlings | |
| | cold night | died | |
| 1-May | emptied cells contained | noted difference in root mass | had already discarded raw |
| | dead plants | between control and | seedling so no observation |
| | | exchanged | |
| 1-May | seeded flat of radishes | | |
| | & other seed types | | |
| 6-May | checked on greenhouse | hard frost again | |
| 6-May | checked on greenhouse | radishes have broken the | noted more seedlings emerged |
| | | surface | from raw flat |
| 7-May | went to Brisco | same size & variety of tomato | purchased two tomato plants |
| | Greenhouse | | |
| 8-May | checked on greenhouse | radish seeds in all containers | control now caught up with rest |
| | | checked | |
| 13-May | checked on greenhouse | raw hanging basket | exchanged hanging basket last in |
| | | outperforming control | growth |
| 18-May | did test on cuttings | | dusted cuttings with raw and |
| | | | exchanged powders and planted |
| | | | control |
| 18-May | planted up tomato in | | both plants at same flowering |
| | one gallon pots | | stage |
| 18-May | checked on hanging | raw and control same level of | took photos |
| | baskets | foliage growth but control has | |
| | | more flowers | |
| 26-May | checked on radish flat | Exchanged flat has larger | checked on hanging baskets |
| | | squash and radish plants, | which now look identical |
| | | control radishes look sick and | |
| | | raw coming in second | |
| 29-May | went to Brisco | all Marigold plants purchased | |
| | Greenhouse | are as close to the same size as | |
| | | possible | |
| 30-May | received first | Noticed all baskets appear to | took photos. Exchanged at 65%, |
| | ph/moisture meter | have the same pH - top end of | raw at 90%, control at 55% |
| | | 7 | |
| 30-May | checked ph on hot tub | all three hanging baskets | |
| | strips | record the same pH and | |
| | | alkalinity - all very high | |
| 2-Jun. | Checked hanging basket | | took photos. Exchanged at 30%, |
| | moisture levels | | raw at 35%, control at 20% |
| 2-Jun. | Checked hanging basket | watered | put one gallon in each hanging |
| | moisture levels | | basket, waited an hour, poured |
| | | | off excess water in reservoir. |
| | | | Note raw had no excess, |
| | | | exchanged had some and control |
| | | | lost about half its water |
| 3-Jun. | Received second set of | Mixed samples and planted | Mixed five samples: natural |
| | samples | out Marigolds | zeolite powder, raw, full |
| | | | exchanged, metals only and |
| | | | control. |
| 3-Jun. | Examined radish flat | determined squash too big to | planted out squash in garden |
| | | remain in flat as watering | took photo |
| | | requirements so high plants | |
| | | almost running out | |
| 3-Jun. | Examined tomatoes | also getting too big to remain | planted out tomatoes in garden |
| | | in greenhouse. Note that | and took photo. |
| | | exchanged tomato already | |
| | | fruiting and greener and bigger | |
| | | than control | |
| 5-Jun. | received 2nd | note pH is same in both meters | difference in moisture levels |
| | pH/moisture meter | | between two meters. Now use |
| | | | one for pH and one for moisture |
| | | | until a more accurate method |
| | | | has been determined |
| 9-Jun. | checked moisture of | note that both zeolite baskets | wait to water control until last |
| | hanging baskets | do not require watering but | minute. Took photos and |
| | | control should be watered | measurements of moisture |
| | | | levels: Control 10%, raw 70%, |
| | | | exchanged 60% |
| 9-Jun. | seeded new radish flat | only did four tests no natural | |
| | | zeolite | |
| 10-Jun. | Checked & watered all | Raw retained all but 8 ozs of | |
| | hanging baskets | water, exchanged and control | |
| | | retained all but 16 ozs of water | |
| 10-Jun. | Checked all cuttings | Herb cuttings failure - control | took pictures |
| | | much better roots. Geranium | |
| | | cuttings did much better with | |
| | | 60% success rate. | |
| 10-Jun. | pulled first radish flat | Exchanged was best roots and | took pictures |
| | | weighing in at 31 grams. | |
| | | Control came in at 10 grams | |
| | | and raw came in at 15 grams. | |

As our invention, we claim:

1. Synthetic zeolite A having at least double the ion exchange capacity of Clinoptilolite, said zeolite A being prepared from a naturally occurring source of silicon and aluminum;
the pH of the zeolite being buffered to between about 6 and 10;
the zeolite having:
a moisture reserve capacity of at least about 25 wt %;
an external surface area of at least about 10 m²/g; and
an ion exchange capacity of at least about 3.5 meq/g (measured on an anhydrous basis),
a plant growth promoter chosen from the group consisting of copper, zinc and mixtures thereof included in the amount of at least about 0.04 meq/g;
and a plant growth nutrient chosen from the group consisting of ammonium, magnesium, potassium and mixtures thereof exchanged into the zeolite in amounts between about 0.5 meq/g up to about 5 meq/g.

2. The Synthetic zeolite of claim 1, having been prepared from kaolin.

3. The Synthetic zeolite of claim 1, having been prepared from calcined delaminated kaolin.

4. The Synthetic zeolite of claim 1, being buffered to a pH of between about 6.5 and 9.

5. The Synthetic zeolite of claim 1, having a moisture reserve capacity of at least 20 wt %.

6. The Synthetic zeolite of claim 1, having an external surface area of at least about 20 m²/g.

7. The Synthetic zeolite of claim 1, having an ion exchange capacity of at least about 4 meq/g.

8. The Synthetic zeolite of claim 1, incorporating a plant growth promoter chosen from the group consisting of copper, zinc and mixtures thereof be included in the amount of at least about 2 meq/g.

9. The Synthetic zeolite of claim 1, further comprising a plant growth nutrient chosen from the group consisting of ammonium, a potassium salt and combinations thereof incorporated into the zeolite in an amount of between about 1.0 meq/g up to about 1.5 meq/g (measured on an anhydrous basis).

10. Zeolite prepared from a naturally occurring source of silicon and aluminum, said zeolite A being buffered to between about 6.5 and 9; having:
a moisture reserve capacity of at least 20 wt %;
an external surface area of at least about 25 m²/g; and
an ion exchange capacity of at least about 4.5 meq/g (measured on an anhydrous basis),
a plant growth promoter chosen from the group consisting of copper, zinc and mixtures thereof included in the amount of at least about 0.3 meq/g; and
a plant growth nutrient chosen from the group consisting of ammonium, magnesium, potassium and mixtures thereof incorporated into the zeolite in amounts between about 1 meq/g up to about 5 meq/g

11. A synthetic high aluminum zeolite wherein the mol ratio of silicon to aluminum (Si/AL) is less than 2.0, having: having at least double the ion exchange capacity of Clinoptilolite, said zeolite being prepared from a naturally occurring source of silicon and aluminum;
the pH of the zeolite being buffered to between about 6 and 9;
the zeolite having:
a moisture reserve capacity of at least about 20 wt %;
an external surface area of at least about 10 m²/g; and
an ion exchange capacity of at least about 3.5 meq/g (measured on an anhydrous basis),
a plant growth promoter chosen from the group consisting of copper, zinc and mixtures thereof included in the amount of at least about 0.4 meq/g;
and a plant growth nutrient chosen from the group consisting of ammonium, magnesium, potassium and mixtures thereof exchanged into the zeolite in amounts between about 3.5 meq/g up to about 25 meq/g.

12. The Synthetic zeolite of claim 11, having been prepared from kaolin.

13. The Synthetic zeolite of claim 12, having been prepared from calcined kaolin.

14. The Synthetic zeolite of claim 11, being buffered to a pH of between about 5.5 and 10.

15. The Synthetic zeolite of claim 11, having a moisture reserve capacity of at least 20 wt %.

16. The Synthetic zeolite of claim 11, having an external surface area of at least about 10 m²/g.

17. The Synthetic zeolite of claim 11, having an ion exchange capacity of at least about 4 meq/g.

18. The Synthetic zeolite of claim 11, incorporating a plant growth promoter chosen from the group consisting of copper, zinc and mixtures thereof included in the amount of at least about 0.02 meq/g.

19. The Synthetic zeolite of claim 11, further comprising a plant growth nutrient chosen from the group consisting of ammonium, a potassium salt and combinations thereof incorporated into the zeolite in an amount of between about 1.0 meq/g up to about 1.5 meq/g (measured on an anhydrous basis).

20. Zeolite A from kaolin, prepared from a naturally occurring source of silicon aluminum and mixtures thereof, said zeolite A being buffered to between about 6 and 8; having:
a moisture reserve capacity of at least 30 wt %;
an external surface area of at least about 10 m²/g; and
an ion exchange capacity of at least about 3.5 meq/g (measured on an anhydrous basis),
a plant growth nutrient chosen from the group consisting of ammonium, magnesium, potassium or mixtures incorporated into the zeolite in amounts between about 0.5 w % up to about 25 wt %.

21. A method of plant growth promotion comprising the steps of mixing synthetic high aluminum zeolite A with soil around seeds of a desired plant.

22. The method of claim 21, wherein the zeolite A has been ion exchanged with nutrients including a plant growth promoter chosen from the group consisting of copper, zinc and mixtures thereof included in the amount of at least about 0.04 meq/g.

23. The method of claim 21 wherein the zeolite A has a moisture reserve capacity of at least about 30 wt %.

24. The method of claim 21 wherein the zeolite A has an ion exchange capacity of at least about 3.5 meq/g (measured on an anhydrous basis),

25. The method of claim 21, wherein the zeolite A has been ion exchanged with nutrients including a plant growth nutrient chosen from the group consisting of ammonium, magnesium, potassium or mixtures incorporated into the zeolite in amounts between about 0.5 w % up to about 25 wt %.

26. The method of claim 21 wherein the zeolite A

27. The method of claim 21 wherein the zeolite A has been prepared from a naturally occurring source of silicon aluminum and mixtures thereof, said zeolite A being buffered to between about 6 and 8.

28. The method of claim 21, wherein the zeolite A has been ion exchanged with nutrients including a plant growth promoter chosen from the group consisting of copper, zinc and mixtures thereof included in the amount of at least about 0.04 meq/g; the zeolite A:
having a moisture reserve capacity of at least about 30 wt %;
having an ion exchange capacity of at least about 3.5 meq/g (measured on an anhydrous basis);
including a plant growth nutrient chosen from the group consisting of ammonium, magnesium, potassium or mixtures incorporated into the zeolite in amounts between about 0.5 w % up to about 25 wt %,
having been buffered to between about 6 and 8; and
has an external surface area of at least about 10 m²/g.
